(19) United States
(12) Patent Application Publication
(10) Pub. No.: US 2020/0047561 A1
(43) Pub. Date: Feb. 13, 2020

(54) TIRE WITH AUDIBLE FUNCTIONALITY

(71) Applicants: BRIDGESTONE CORPORATION, Tokyo (JP); BRIDGESTONE AMERICAS TIRE OPERATIONS, LLC, Nashville, TN (US)

(72) Inventors: Terence E. WEI, Copley, OH (US); Sheel P. AGARWAL, Solon, OH (US)

(73) Assignees: Bridgestone Corporation, Tokyo (JP); Bridgestone Americas Tire Operations, LLC, Nashville, TN (US)

(21) Appl. No.: 16/339,410

(22) PCT Filed: Oct. 5, 2017
(86) PCT No.: PCT/US2017/055234

§ 371 Date: Apr. 4, 2019

Related U.S. Application Data
(60) Provisional application No. 62/404,895, filed on Oct. 6, 2016.

(51) Int. Cl. B60C 11/24

(52) U.S. Cl. CPC B60C 11/24; B60C 2019/006

(57) ABSTRACT

A tire having structures used to notify a driver, passenger, or other observer that a tire tread has worn to a predetermined limit is disclosed. Lattice plies, lattices, meshes, and/or films which are disposed within a tire produce an audible signal that indicates a tire tread has worn to a predetermined limit. The lattice plies, lattices, meshes, and/or films may be used a variety of tire applications.

### FIELD OF INVENTION

This disclosure relates to structures and methods used to notify a driver, passenger, or other observer that a tire tread has worn to a predetermined limit. More particularly, the disclosure relates to lattice plies, lattices, meshes, and/or films disposed within a tire that produce an audible signal that indicates a tire tread has worn to the predetermined limit. The lattice plies, lattices, meshes, and/or films may be used in a variety of tire applications, including without limitation, passenger, light truck, and truck-and-bus radial applications.

### BACKGROUND

Structures and methods for gauging tread wear are known. For example, tread wear indicators provide a visual indication that a tire tread has worn to a predetermined limit, and the “penny test” (i.e., inserting a penny into a groove to measure the height of a tread element relative to a feature of the coin) and direct measurements have been used to ascertain tread depth. These structures and tests require physical observation (when the tire is stationary) in order to determine the tread depth.

### SUMMARY OF THE INVENTION

In one embodiment, a tire comprises a first annular bead and a second annular bead; a body ply extending between the first annular bead and the second annular bead; an annular belt package, including a first annular belt, disposed radially upward of the body ply and extending axially across a portion of the body ply, and a second annular belt, disposed radially upward of the first annular belt and extending axially across a portion of the body ply; and a circumferential tread, disposed radially above the annular belt package, comprising at least a tread cap and a tread base, both of which extend axially across a portion of the body ply. The tire further includes a lattice ply comprising nodes and a connective medium, disposed radially between the annular belt package and the tread cap, and extending axially across a portion of the body ply and a first sidewall extending between the first annular bead and a first shoulder, the first shoulder being associated with the circumferential tread, and a second sidewall extending between the second annular bead and a second shoulder, the second shoulder being associated with the circumferential tread.

In another embodiment, a tire comprises at least one annular structure configured to interface with a wheel; a circumferential tread disposed in a crown region of the tire; and a lattice ply that produces audible noise when exposed to a traveling surface. The lattice ply extends axially across a portion of the annular structure configured to interface with a wheel, and the lattice ply is disposed radially between the annular structure configured to interface with a wheel and the tread cap.

In a different embodiment, a lattice for use in a tire comprises a plurality of cores having a Shore A hardness of between 70 and 100 and a plurality of connecting filaments, wherein at least a portion of the connecting filaments connect to at least one core; at least a portion of the connecting filaments meet at a plurality of intersections; and at least a portion of the connecting filaments define interstices.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a peel-away cross-sectional perspective view of an embodiment of a tire including a lattice ply;

FIG. 2a is a front cross-sectional view of the tire including a lattice ply shown in FIG. 1;

FIG. 2b is a front cross-sectional view of an alternative embodiment of a tire and lattice ply;

FIG. 2c is a front cross-sectional view of another alternative embodiment of a tire and lattice ply;

FIG. 3a is a representative schematic drawing illustrating one embodiment of a lattice for use in a tire;

FIG. 3b is a representative schematic drawing illustrating an alternative embodiment of a lattice for use in a tire;

FIG. 3c is a representative schematic drawing illustrating another alternative embodiment of a lattice for use in a tire;

FIG. 3d is a representative schematic drawing illustrating one embodiment of a mesh for use in a tire;

FIG. 3e is a representative schematic drawing illustrating an alternative embodiment of a mesh for use in a tire;

FIG. 3f is a representative schematic drawing illustrating one embodiment of a film for use in a tire;

FIG. 4 is close-up top plan view of one embodiment of fibers suitable for use in a tire;

FIG. 5a is a side cross-sectional view of one embodiment of a non-pneumatic tire including a lattice; and

FIG. 5b is a side cross-sectional view of an alternative embodiment of a non-pneumatic tire including a lattice.

### DETAILED DESCRIPTION

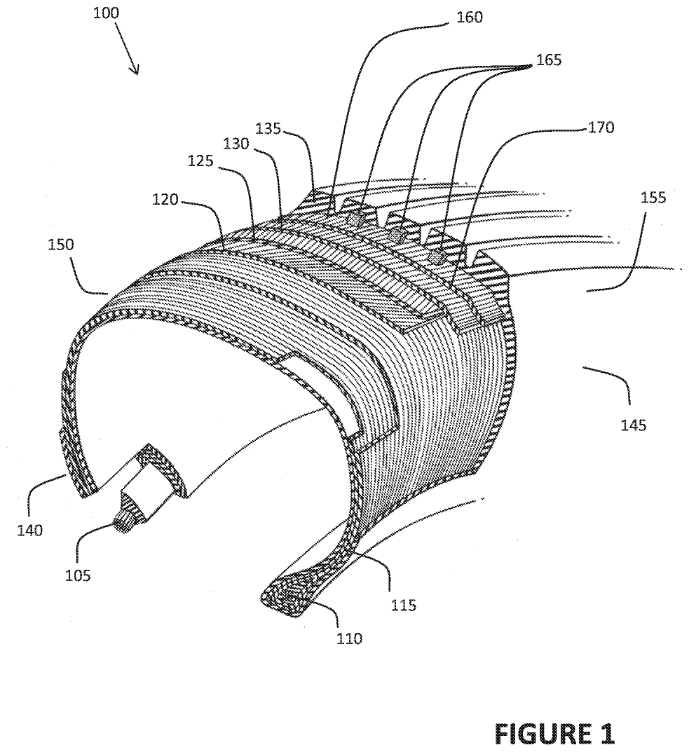

FIG. 1 is a peel-away cross-sectional perspective view of an embodiment of a pneumatic tire 100. Tire 100 includes a first annular bead 105 and a second annular bead 110. The annular beads, in part, secure the tire to a wheel. In an alternative embodiment (not shown), the tire comprises four or more beads.

As shown, tire 100 further includes a body ply 115 extending between first annular bead 105 and second annular bead 110. Body ply 115 forms an annulus and imparts shape to the tire. As one of ordinary skill in the art will understand, body ply 115 may contain reinforcing cords (not labeled) or fabric (not shown). In alternative embodiments (not shown), various turn-up and turn-down configurations, or multiple body plies, are used.

Tire 100 further includes an annular belt package which includes a first annular belt 120 and a second annular belt 125. First annular belt 120 is disposed radially upward of body ply 115 and extends axially across a portion of body ply 115. Second annular belt 125 is disposed radially upward of first annular belt 120 and extends axially across a portion of body ply 115. As one of ordinary skill in the art will understand, the annular belts may contain steel cords and reinforcing cords (both not shown). In an alternative embodiment (not shown), the belt package includes a third annular belt.

As illustrated in FIG. 1, tire 100 further comprises a cap ply 130. Cap ply 130 is disposed radially above first annular belt 120 and second annular belt 125. Cap ply 130 extends axially across a portion of body ply 115. In an alternative embodiment (not shown), a sealing gel layer is provided in the cap ply region.

Tire 100 further comprises a circumferential tread 135. Circumferential tread 135 is disposed radially upward of cap ply 130 (and the belt package) and extends axially across a portion of body ply 115. The width of the circumferential tread 135 is known as the tread width. As depicted, four circumferential grooves divide circumferential tread 135 into five ribs. As one of ordinary skill in the art will understand, a circumferential tread may contain additional elements such as, without limitation, axial grooves, sacrificial ribs, sipes, stone ejectors, and tie bars. As one of ordinary skill in the art will also understand, the circumferential tread is affixed to the tire (e.g., by vulcanization) when the tire is new. In an alternative embodiment (not shown), the circumferential tread is affixed as a retread.

Tire 100 further comprises a first sidewall 140 and a second sidewall 145. First sidewall 140 extends between the first annular bead 105 and a first shoulder 150, which is proximately associated with an edge of circumferential tread 135. Second sidewall 145 extends between the second annular bead 110 and a second shoulder 155, which is proximately associated with an opposite edge of circumferential tread 135. In alternative embodiments (not shown), the sidewall includes one or more sidewall protector(s), electronic device(s), and/or cooling fin(s).

Tire 100 includes a lattice ply 160 that comprises nodes 165 and a connective medium 170. Lattice ply 160 is disposed radially above cap ply 130, and expends axially across a portion of body ply 115. In one embodiment, the lattice ply has a width between 20 and 100% of the tread width. In an alternative embodiment (not shown), the lattice ply has a width between 40 and 90% of the tread width.

With continued reference to FIG. 1, nodes 165 protrude from lattice ply 160 into circumferential tread 135, but are wholly contained by the tread 135. As circumferential tread 135 wears due to use, nodes 165 become exposed and will contact the road. In contacting the road, nodes 165 will produce an audible signal that indicates circumferential tread 135 is worn. In one embodiment (not shown), the nodes extend into a tread cap (which is not shown). In an alternative embodiment, the nodes extend to the surface of a tread base (also not shown). In an alternative embodiment, the nodes extend only into a tread base.

As illustrated in FIG. 1, nodes 165 are rectangular prisms. In an alternative embodiment (not shown), the nodes have a domed surface. In another alternative embodiment, the nodes have a flared base. As one of ordinary skill in the art will understand, the nodes may be a variety of three-dimensional shapes.

In one embodiment, the nodes are made of a durable material having a Shore A hardness of between 70 and 100. In an alternative embodiment, the nodes are made of a durable material having a Shore A hardness of between 75 and 90. In a second embodiment, the nodes have a Shore D hardness between 50 and 100. In an alternative embodiment, the nodes have a Shore D hardness between 70 and 90.

With continued reference to FIG. 1, connective medium 170 is a thin sheet or film of material that extends (at least partially) between the edges of lattice ply 160. In one embodiment (not explicitly shown), the connective medium is an elastomer. In alternative embodiments, the connective medium is selected from the group consisting of fabrics, synthetic polymers, plastics, and thermoplastics.

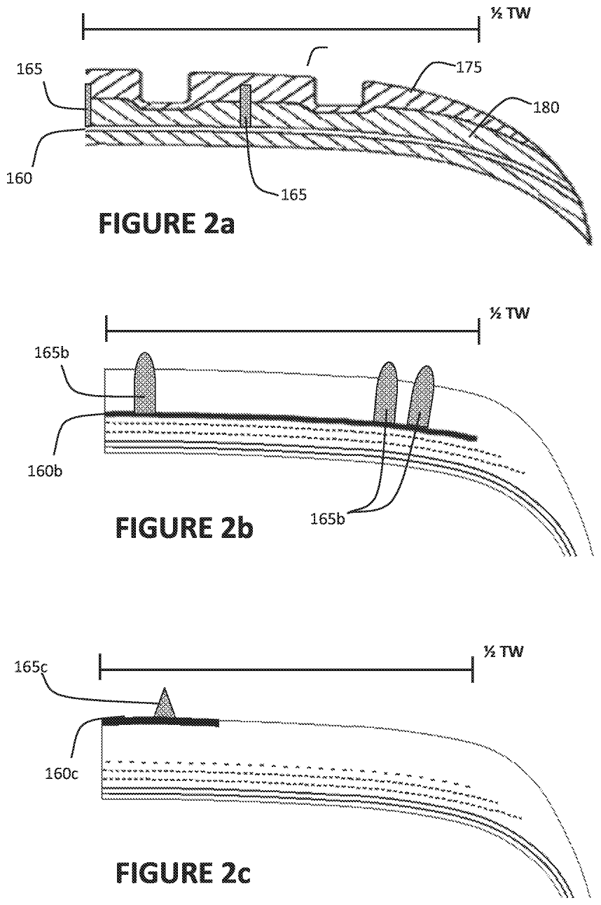

FIG. 2a is a front cross-sectional view of the tire including the lattice ply 160 shown in FIG. 1. Like elements are identified with like numbering.

As shown in FIG. 2a, tread 135 further includes a tread cap 175 and a tread base 180. Tread base 180 is disposed radially upward of cap ply 130 (and the belt package) and extends axially across a portion of body ply 115. Tread cap 175 is disposed radially upward of tread base 180 and extends axially across a portion of body ply 115. Tread cap 175 may be formulated to possess particular performance attributes that are desirable when the tire is new. As one of ordinary skill in the art will understand, the tread cap and tread base are normally made of different compounds.

As further shown in FIG. 2a, lattice ply 160 is embedded within tread base 180. Nodes 165 extend from lattice ply 160, through tread base 180, into tread cap 165. The lattice ply (including the nodes) may be co-extruded with the tread base. In an alternative embodiment, the lattice ply is laid upon a given tire component.

FIG. 2b is a front cross-sectional view of an alternative embodiment of the tire including a lattice ply 160 shown in FIG. 2a. The FIG. 2b embodiment is substantially the same as the FIG. 2a embodiment, except for the differences discussed below.

In this embodiment, the tire shown in FIG. 2b is a casing suitable for use in retread applications. The tread (or retread) portion of the tire is omitted from the figure. As shown, the nodes 165b have a domed tip. Further, nodes 165b are spaced unevenly along the same axial line. For this half of the tire, one node is disposed in a middle region of the tread (such as a rib) and two nodes are disposed on an outer region of the tread (such as a rib). In this particular embodiment, the nodes extend from the lattice ply 160b through the tire.

FIG. 2c is a front cross-sectional view of alternative embodiment of the tire including a lattice ply shown in FIG. 2a. The FIG. 2c embodiment is substantially the same as the FIG. 2b embodiment, except for the differences discussed below.

In this embodiment, lattice ply 160c is disposed at the top surface of the tire casing. Node 165c, which is shown as having a pointed tip, extends out of lattice ply 160c. Further, as shown, lattice ply 160c has a width between 5 and 30% of the tread width.

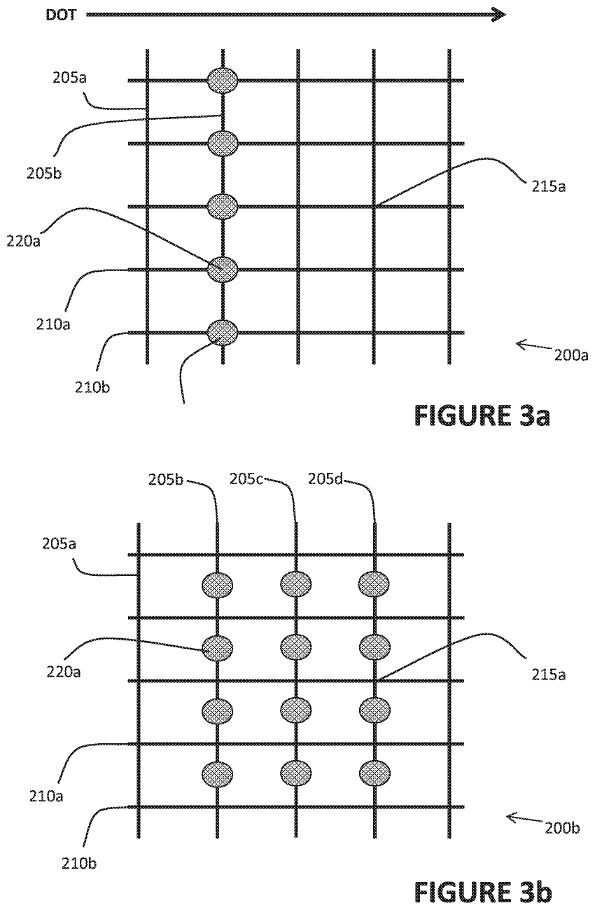

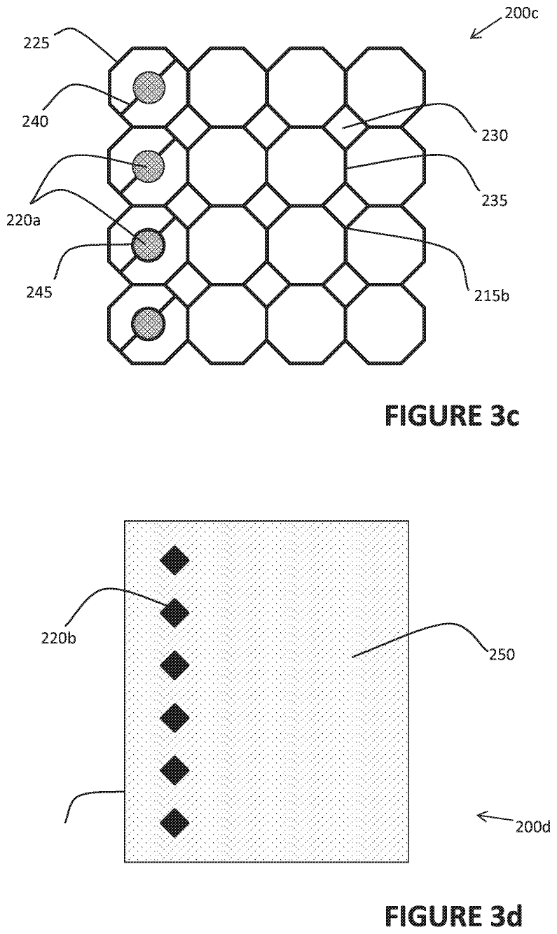

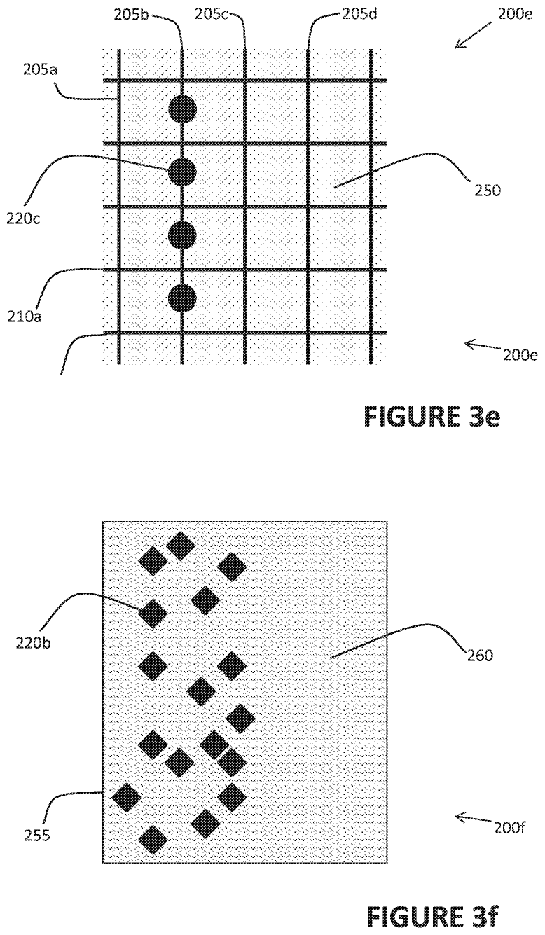

FIG. 3a is a representative schematic drawing illustrating one embodiment of a lattice 200a for use in a tire. Lattice 200a is an example of a particular type of lattice ply having audible functionality.

Lattice 200a includes axial filaments 205a and 205b and circumferential filaments 210a and 210b. Axial filaments 205a and 205b and circumferential filaments 210a and 210b are two examples of connecting filaments. As shown, lattice 200a includes a plurality of connecting filaments. Axial filaments 205a and 205b are disposed perpendicular to the direction of travel DOT, while the circumferential filaments are disposed parallel to the direction of travel DOT. In an alternative embodiment (not shown), the circumferential filaments are only approximately circumferential, and are in fact disposed at an acute angle relative to the circumferential direction (e.g., under 45° divergence from the circumferential direction) and the axial filaments are only approximately axial, and are in fact disposed at an acute angle relative to the axial direction (e.g., under 45° divergence from the axial direction). In another alternative embodiment, the axial and/or circumferential filaments are disposed at a 45° with respect to the direction of travel.

As shown in FIG. 3a, axial filaments 205a and 205b meet circumferential filaments 210a and 210b at intersection 215a. As shown, lattice 200a includes a plurality of intersections. The intersections define a plurality of interstices. In one embodiment (not shown), the axial filaments are spaced between 5 and 20 cm apart. In an alternative embodiment, the axial filaments are spaced between 0.5 and 2.0 cm apart.

As shown in FIG. 3a, lattice 200a further includes cores 220a and 220b. In contrast to the nodes 165, cores 220a and 220b have a generally symmetrical upper and lower half. As a tire tread wears due to use, the cores will become exposed and will contact the road. In contacting the road, the cores will produce an audible signal that indicates the tire tread is worn.

As shown, axial filament 205b connects to core 220a Likewise, the circumferential filaments, e.g., 210a and 210b, also connect to the cores, e.g., 220a and 220b. As shown, lattice 200a includes a plurality of cores. In one embodiment (not shown), filaments connect to the cores by passing through them. In further alternative embodiments, the filaments connect to the cores by surrounding or at least partially surrounding the cores. In yet another alternative embodiment, the cores encapsulate polyurethane foam which expands when the cores breach.

Although not shown in FIG. 3a, the connecting filaments are made of material selected from the group consisting of nylon, rayon, aramid, para-aramid, polyester, polyethylene, polyethylene naphthalate (PEN), polyethylene terephthalate (PET), polyvinyl alcohol (PVOH or PVA), polybenzobisoxazole (PBO or Zylon), ethylene carbon monoxide copolymer (POK), carbon fiber, fiberglass, steel, and aluminum. The cores may be made of material selected from the group consisting of PVC, phenol formaldehyde resins, nylon, polystyrene, polyethylene, polypropylene, polyoxymethylene, polyphenylene oxide, polyphenylene sulphide, polyester, polyurethane, acrylonitrile, and butadiene styrene.

FIG. 3b is a representative schematic drawing illustrating an alternative embodiment of a lattice 200b for use in a tire. The FIG. 3b embodiment is substantially the same as the FIG. 3a embodiment, except for the differences discussed below.

Lattice 200b includes a plurality of cores 220a. As shown, the plurality of cores is disposed over disparate axial filaments (205b-d) rather than at the interstices. Disposing the cores over disparate axial filaments alters the audible noise produced when the cores contact the road. In a particular embodiment (not shown), a linear distance of 10 to 20 cm separates adjacent cores. In an alternative embodiment, a linear distance of 2 to 10 cm separates adjacent cores.

FIG. 3c is a representative schematic drawing illustrating another alternative embodiment of a lattice 200c for use in a tire.

Lattice 200c includes octagonal filaments 225 that form interstices 230 and common edges 235. Octagonal filaments 225 further include connecting filaments 240 that connect to cores 220a. In alternative embodiments (not shown), different polygonal shapes are used in lieu of octagons.

With continued reference to FIG. 3c, filament 245 surrounds core 220a. In an alternative embodiment (not shown), the cores include a notch to receive a connecting filament.

FIG. 3d is a representative schematic drawing illustrating an alternative embodiment of a mesh 200d for use in a tire. Mesh 200d is an example of a particular type of lattice ply having audible functionality.

In mesh 200d, a plurality of filaments 250 is provided, and a portion of the filaments secure cores 220b. In contrast to the lattices shown in FIGS. 3a-3c, multiple filaments are connected to each core. Edge 255 is depicted for illustrative purposes only.

FIG. 3e is a representative schematic drawing illustrating one embodiment of a mesh 200e for use in a tire. The FIG. 3e embodiment is substantially the same as the FIG. 3d embodiment, except for that mesh 200e is provided in conjunction with a lattice (as discussed with relation to FIGS. 3a-3c) to simplify the tire manufacturing process.

FIG. 3f is a representative schematic drawing illustrating one embodiment of a film 200f for use in a tire. Film 200f is an example of a particular type of lattice ply having audible functionality. The FIG. 3f embodiment is substantially the same as the FIG. 3a embodiment, except for the differences discussed below.

In FIG. 3f, film 200f secures cores 200b. Film 200f is made of a plastic (or other thin polymeric material) and at least partially surrounds cores 220b (e.g., the cores are embedded in the film). In an alternative embodiment (not shown), the cores are disposed between two films. In another alternative embodiment, the cores are affixed to the film with an adhesive.

As shown in FIG. 3f, cores 220b are unevenly distributed across film medium 260. In one embodiment (not shown), the cores are distributed within a 5 cm linear distance with respect to the direction of travel. In an alternative embodiment, the cores are distributed within a 2 cm linear distance with respect to the direction of travel. In another alternative embodiment, the film is provided in conjunction with a lattice (as discussed with relation to FIGS. 3a-3c).

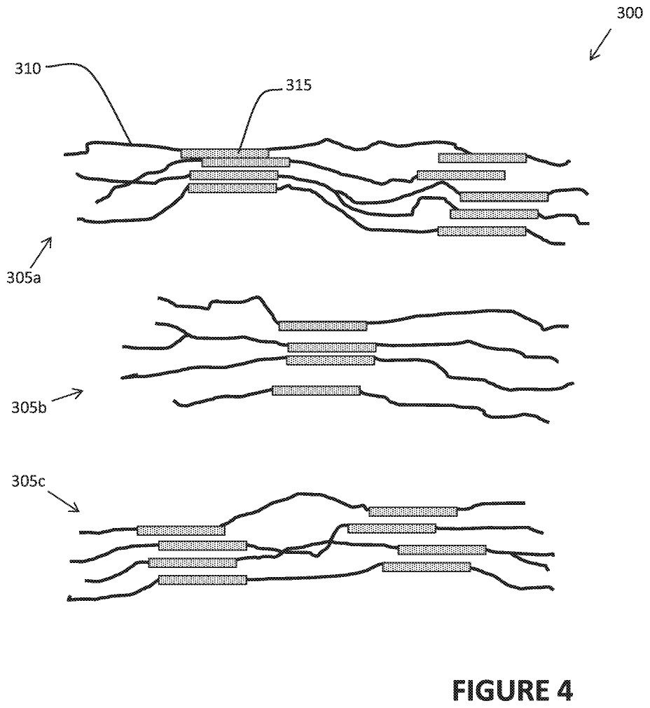

FIG. 4 is close-up top plan view of fibers 300 suitable for use in a tire. Fibers 300 may be assembled into a lattice, mesh, or circumferential band that constitute a particular type of lattice ply having audible functionality. This particular type of lattice ply does not contain nodes or cores.

In the illustrated embodiment, fibers 300 include a first plurality of polyurethane domains 310 and a second plurality of polyurethane domains 315. The polyurethane domains in the second plurality of polyurethane domains 315 are harder than the polyurethane domains in the first plurality of polyurethane domains 310. Although not shown, the polyurethane domains in the second plurality of polyurethane domains emit an audible signal when they contact the road.

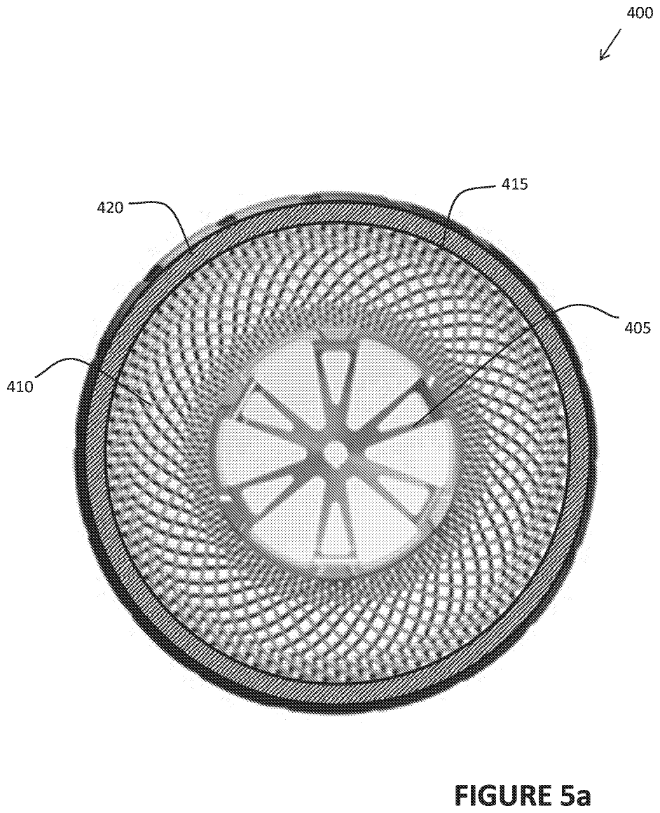

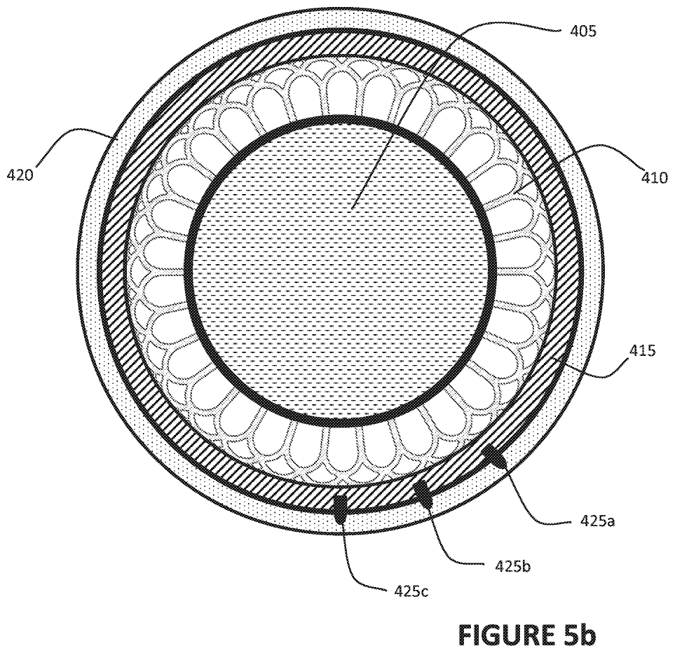

FIG. 5a is a side cross-sectional view of a tire 400 including a lattice ply 415. As shown, tire 400 is a non-pneumatic tire, with wheel 405, spokes 410, and tread 420 shown for context. Lattice ply 415 is disposed radially between spokes 410 and tread 420. As tread 420 wears due to use, lattice ply 415 will become exposed and will contact the road. In contacting the road, lattice ply 415 will produce an audible signal that indicates tread 420 is worn.

FIG. 5b is a side cross-sectional view of an alternative embodiment of a tire including a lattice 415. The FIG. 5b embodiment is substantially the same as the FIG. 5a embodiment, except for the differences discussed below.

As shown in FIG. 5b, nodes 425a, 425b, and 425c extend from lattice 415 into tread 420. In the illustrated embodiment, the nodes are disposed within one quadrant of the tire. In an alternative embodiment (not shown), the nodes are distributed in disparate quadrants.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1-15. (canceled)

16. A tire comprising:
a first annular bead and a second annular bead;
a body ply extending between the first annular bead and the second annular bead;
an annular belt package, including a first annular belt, disposed radially upward of the body ply and extending axially across a portion of the body ply, and a second annular belt, disposed radially upward of the first annular belt and extending axially across a portion of the body ply;
a circumferential tread, disposed radially above the annular belt package, comprising at least a tread cap and a tread base, both of which extend axially across a portion of the body ply;
a lattice ply comprising nodes and a connective medium, disposed radially between the annular belt package and the tread cap, and extending axially across a portion of the body ply; and
a first sidewall extending between the first annular bead and a first shoulder, the first shoulder being associated with the circumferential tread, and a second sidewall extending between the second annular bead and a second shoulder, the second shoulder being associated with the circumferential tread.

17. The tire of claim 16, wherein the nodes have a Shore D hardness between 50 and 100.

18. The tire of claim 16, wherein the nodes have a domed surface.

19. The tire of claim 16, wherein the nodes extend into the tread cap.

20. The tire of claim 16, wherein the lattice ply has a width between 20 and 100% of the tread width.

21. The tire of claim 16, wherein at least three nodes are disposed on disparate axial lines.

22. A lattice for use in a tire, comprising:
a plurality of cores having a Shore A hardness of between 70 and 100 and a plurality of connecting filaments,
wherein at least a portion of the connecting filaments connect to at least one core;
wherein at least a portion of the connecting filaments meet at a plurality of intersections, and
wherein at least a portion of the connecting filaments define interstices.

23. The lattice of claim 22, wherein the axial filaments are spaced between 5 and 20 cm apart.

24. The lattice of claim 22, wherein at least a portion of the connecting filaments at least partially surround the cores.

25. The lattice of claim 22, wherein the cores further include a notch to receive a connecting filament.

26. The lattice of claim 22, wherein a linear distance of between 2 and 20 cm separates adjacent cores.

27. The lattice of claim 22, wherein the cores are selected from the group consisting of PVC, phenol formaldehyde resins, nylon, polystyrene, polyethylene, polypropylene, polyoxymethylene, polyphenylene oxide, polyphenylene sulphide, polyester, polyurethane, acrylonitrile, butadiene styrene, carbon fiber, fiberglass, steel and aluminum

28. The lattice of claim 22, wherein the connecting filaments are made of material selected from the group consisting of nylon, rayon, aramid, para-aramid, polyester, polyethylene, polyethylene naphthalate (PEN), polyethylene terephthalate (PET), polyvinyl alcohol (PVOH or PVA), polybenzobisoxazole (PBO or Zylon), ethylene carbon monoxide copolymer (POK), carbon fiber, fiberglass, steel, and aluminum.

29. A tire comprising:
at least one annular structure configured to interface with a wheel;
a circumferential tread disposed in a crown region of the tire; and
a lattice ply that produces audible noise when exposed to a traveling surface,
wherein the lattice ply extends axially across a portion of the annular structure configured to interface with a wheel, and
wherein the lattice ply is disposed radially between the annular structure configured to interface with a wheel and the tread cap.

30. The tire of claim 29, wherein the lattice ply further includes cores having a Shore D hardness between 50 and 100.

31. The tire of claim 29, wherein the lattice ply further includes interstices.

32. The tire of claim 29, wherein the lattice ply further includes a first plurality of polyurethane domains and a second plurality of polyurethane domains, wherein the polyurethane domains in the second plurality of polyurethane domains are harder than the polyurethane domains in the first plurality of polyurethane domains.

33. The tire of claim 29, wherein the circumferential tread includes a tread cap and a tread base and the lattice ply is disposed radially between the tread cap and the tread base.

34. The tire of claim 29, wherein the lattice ply further includes protrusions which are disposed radially below the outer thirds of the tread width.

35. The tire of claim 29, wherein the lattice ply further includes encapsulated urethane foam.
